(19) United States
(12) Patent Application Publication
(10) Pub. No.: US 2019/0080610 A1
(43) Pub. Date: Mar. 14, 2019

(54) VEHICLE CONTROL APPARATUS, VEHICLE, PROCESSING METHOD OF VEHICLE CONTROL APPARATUS, AND STORAGE MEDIUM

(71) Applicant: HONDA MOTOR CO., LTD., Tokyo (JP)

(72) Inventor: Toru Kokaki, Wako-shi (JP)

(21) Appl. No.: 16/100,497

(22) Filed: Aug. 10, 2018

(30) Foreign Application Priority Data
Sep. 13, 2017 (JP) 2017-175784

(51) Int. Cl. G08G 1/16; G05D 1/02; G08G 1/01; G01S 19/42

(52) U.S. Cl. CPC G08G 1/166; G05D 1/0212; G05D 1/0088; G08G 1/167; G01S 19/42; G08G 1/0112

(57) ABSTRACT

A vehicle control apparatus comprising: a specifying unit that specifies a branch position to branch from a traveling lane on which a self-vehicle travels to a plurality of lanes in a plurality of advancing directions; a detection unit that detects one of preceding and following vehicles of the self-vehicle based on the peripheral information of the self-vehicle; and a control unit that, in a case where the self-vehicle is traveling within a predetermined range from the branch position, and at least one of the preceding and following vehicles is located at a position offset with respect to a lane center of the traveling lane or the self-vehicle, offsets the self-vehicle with respect to the lane center based on an offset direction of one of the preceding and following vehicles and an advancing direction of the self-vehicle.

### BACKGROUND OF THE INVENTION

### Field of the Invention

The present invention relates to a vehicle control apparatus, a vehicle, a processing method of the vehicle control apparatus, and a storage medium.

### Description of the Related Art

WO 2016/031036 discloses a technique of, when a self-vehicle travels on the lane center and branches at a branch point, performing offset control according to the course change direction, thereby reducing the sense of incongruity of the driver caused by an abrupt course change.

However, in the technique of WO 2016/031036, controlling the travel of the self-vehicle with consideration for the travel of other vehicles on the periphery of the self-vehicle is not taken into consideration.

The present invention provides a technique for implementing automated driving with consideration for the travel of other vehicles.

### SUMMARY OF THE INVENTION

According to one aspect of the present invention, there is provided a vehicle control apparatus comprising: an acquisition unit configured to acquire peripheral information of a self-vehicle; a specifying unit configured to specify a branch position to branch from a traveling lane on which the self-vehicle travels to a plurality of lanes in a plurality of advancing directions; a detection unit configured to detect one of a preceding vehicle and a following vehicle of the self-vehicle based on the peripheral information; and a control unit configured to, in a case in which the self-vehicle is traveling within a predetermined range from the branch position, and at least one of the preceding vehicle and the following vehicle is located at a position offset with respect to a lane center of the traveling lane or with respect to the self-vehicle, perform offset control to offset the self-vehicle with respect to the lane center based on an offset direction of one of the preceding vehicle and the following vehicle and an advancing direction of the self-vehicle.

### BRIEF DESCRIPTION OF THE DRAWINGS

FIG. 1 is a block diagram for explaining an example of the arrangement of a vehicle;

FIG. 2 is a plan view for explaining an example of arrangement positions of detection units;

FIG. 3 is a flowchart showing an example of automated driving processing according to an embodiment;

FIG. 4 is an explanatory view of an example of offset control in a case in which the advancing direction of a self-vehicle is the same as the offset direction of a preceding vehicle;

FIG. 5 is an explanatory view of an example of offset control in a case in which the advancing direction of the self-vehicle is the same as the offset direction of the preceding vehicle and a following vehicle;

FIG. 6 is an explanatory view of an example of offset control in a case in which the following vehicle is located at a position offset with respect to the lane center or with respect to the self-vehicle, and the advancing direction of the self-vehicle is a direction other than a straight advancing direction (left turn or right turn); and

FIG. 7 is an explanatory view of an example of offset control in a case in which the following vehicle is located at a position offset with respect to the lane center or with respect to the self-vehicle, and the advancing direction of the self-vehicle is the straight advancing direction.

### DESCRIPTION OF THE EMBODIMENTS

An embodiment of the present invention will now be described with reference to the accompanying drawings. Note that the drawings are schematic views showing structures or arrangements according to the embodiment, and the dimensions of members shown in the drawings do not necessarily reflect the actuality.

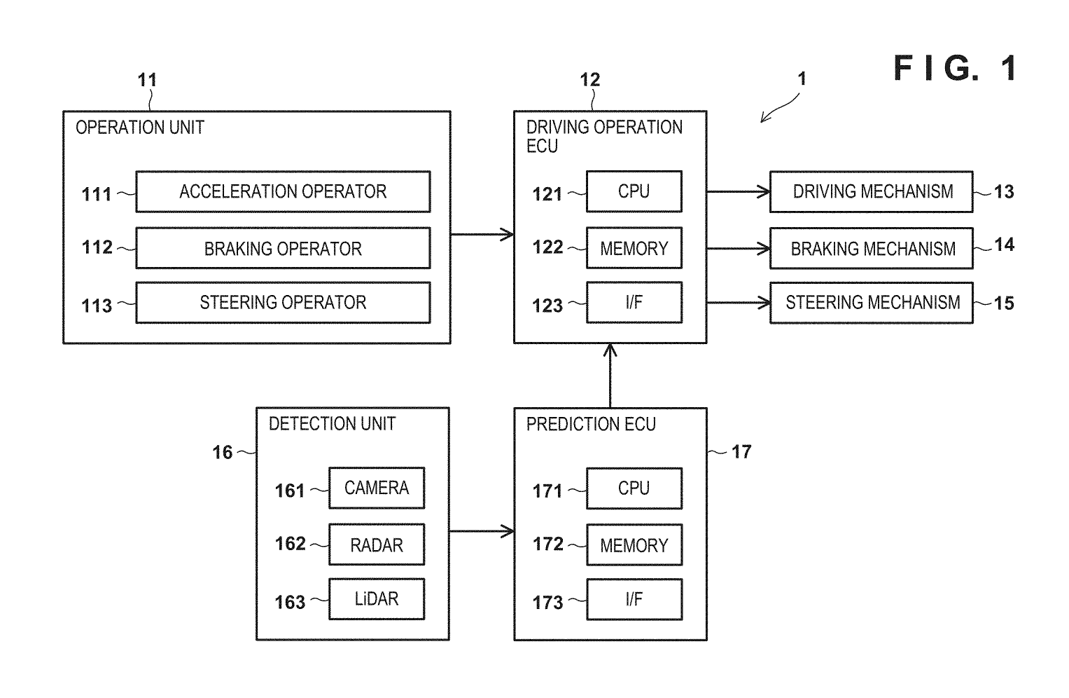

FIG. 1 is a block diagram for explaining the arrangement of a vehicle 1 according to the first embodiment. The vehicle 1 includes an operation unit 11, an driving operation ECU (Electronic Control Unit) 12, a driving mechanism 13, a braking mechanism 14, a steering mechanism 15, a detection unit 16, and a prediction ECU 17. Note that in this embodiment, the vehicle 1 is a four-wheeled vehicle. However, the number of wheels is not limited to four.

The operation unit 11 includes an acceleration operator 111, a braking operator 112, and a steering operator 113. Typically, the acceleration operator 111 is an accelerator pedal, the braking operator 112 is a brake pedal, and the steering operator 113 is a steering wheel. However, a lever type or a button type may be used for the operators 111 to 113.

The driving operation ECU 12 includes a CPU 121, a memory 122, and a communication interface 123. The CPU 121 performs predetermined processing based on an electrical signal received from the operation unit 11 via the communication interface 123. Then, the CPU 121 stores the processing result in the memory 122 or outputs it to the mechanisms 13 to 15 via the communication interface 123. With this arrangement, the driving operation ECU 12 controls the mechanisms 13 to 15.

The driving operation ECU 12 is not limited to this arrangement, and a semiconductor device such as an ASIC (Application Specific Integrated Circuit) may be used as another embodiment. That is, the function of the driving operation ECU 12 can be implemented by either hardware or software. In addition, the driving operation ECU 12 is shown here as a single element for the sake of descriptive simplicity but may be divided into a plurality of elements. The driving operation ECU 12 may be divided into, for example, three ECUs for acceleration, braking, and steering.

The driving mechanism 13 includes, for example, an internal combustion engine and a transmission. The braking mechanism 14 is, for example, a disc brake provided on each wheel. The steering mechanism 15 includes, for example, a power steering. The driving operation ECU 12 controls the driving mechanism 13 based on the operation amount of the acceleration operator 111 by a driver. In addition, the driving operation ECU 12 controls the braking mechanism 14 based on the operation amount of the braking operator 112 by the driver. Also, the driving operation ECU 12 controls the steering mechanism 15 based on the operation amount of the steering operator 113 by the driver.

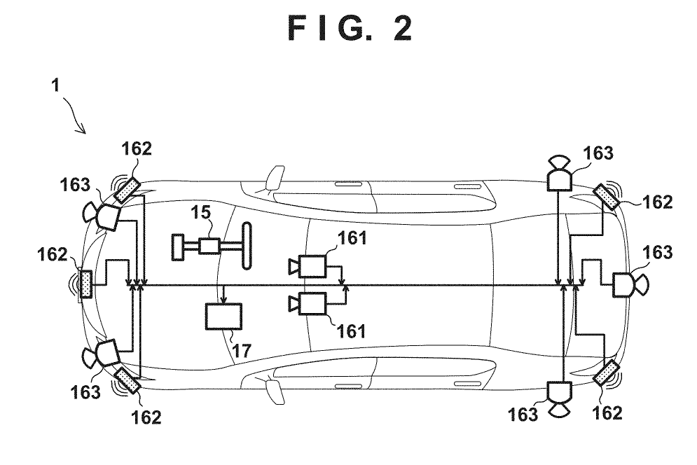

The detection unit 16 includes a camera 161, a radar 162, and a LiDAR (Light Detection and Ranging) 163. The camera 161 is, for example, an image capturing device using a CCD/CMOS image sensor. The radar 162 is, for example, a distance measuring device such as a millimeter-wave radar. The LiDAR 163 is, for example, a distance measuring device such as a laser radar. These devices are arranged at positions where peripheral information of the vehicle 1 can be detected, for example, on the front side, rear side, upper side, and lateral sides of the vehicle body, as shown in FIG. 2.

Here, in this specification, expressions such as front, rear, upper, and lateral (left/right) are sometimes used. These are used as expressions indicating relative directions based on the vehicle body. For example, “front” indicates the front in the longitudinal direction of the vehicle body, and “upper” indicates the height direction of the vehicle body.

The vehicle 1 can perform automated driving based on the detection result (the peripheral information of the vehicle 1) by the detection unit 16. In this specification, automated driving means partially or wholly performing the driving operation (acceleration, braking, and steering) not on the driver side but on the side of the driving operation ECU 12. That is, the concept of automated driving includes a form (so-called full automated driving) in which the driving operation is wholly performed on the side of the driving operation ECU 12 and a form (so-called driving support) in which part of the driving operation is performed on the side of the driving operation ECU 12. Examples of driving support are a vehicle speed control (automatic cruise control) function, a following distance control (adaptive cruise control) function, a lane departure prevention support (lane keep assist) function, a collision avoidance support function, and the like.

The prediction ECU 17 predicts the behavior of each object (for example, another vehicle) on a road. The prediction ECU 17 may be referred to as a prediction apparatus, a behavior prediction apparatus, or the like, or may be referred to as a processing apparatus (processor), an information processing apparatus, or the like (or may be called a device, module, unit, or the like in place of an apparatus). When performing automated driving, the driving operation ECU 12 controls some or all of the operators 111 to 113 based on the prediction result of the prediction ECU 17. The prediction ECU 17 and the driving operation ECU 12 may be referred to as a vehicle control apparatus altogether.

The prediction ECU 17 has the same arrangement as the driving operation ECU 12, and includes a CPU 171, a memory 172, and a communication interface 173. The CPU 171 acquires peripheral information of the vehicle 1 from the detection unit 16 via the communication interface 173. The CPU 171 predicts the behavior of each object on the road based on the peripheral information, and stores the prediction result in the memory 172 or outputs it to the driving operation ECU 12 via the communication interface 173. The CPU 171 can also receive GPS information representing the position of the self-vehicle and recognize the position of the self-vehicle on a map.

<Automated Driving Processing>

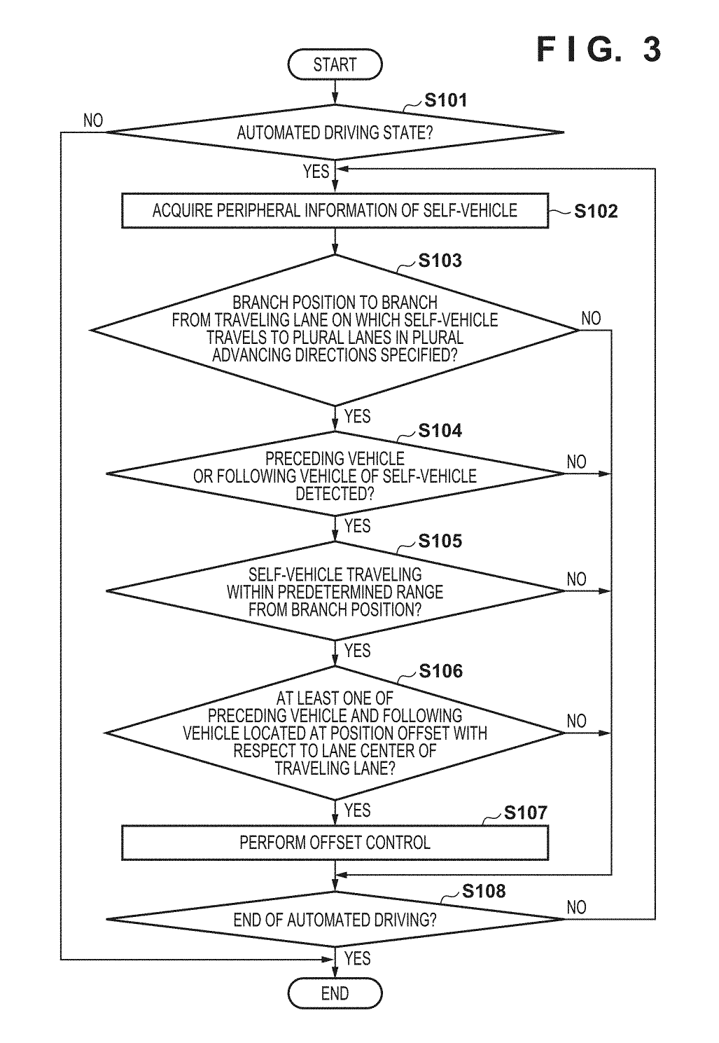

FIG. 3 is a flowchart showing the procedure of processing for performing automated driving according to this embodiment. The contents of the flowchart are mainly performed by the CPU 171 of the prediction ECU 17 and the CPU 121 of the driving operation ECU 12. When the self-vehicle 1 starts automated driving, the prediction ECU 17 recognizes each object on the periphery of the self-vehicle 1 based on the peripheral information of the self-vehicle 1, predicts the behavior of each object, and outputs the result to the driving operation ECU 12. The driving operation ECU 12 controls the operation of the self-vehicle 1 based on the prediction result acquired from the prediction ECU 17.

In step S101, the prediction ECU 17 determines whether the self-vehicle 1 is in the automated driving state or not. This step is performed when, for example, the prediction ECU 17 receives a signal representing whether the self-vehicle 1 is in the automated driving state or not from the driving operation ECU 12. If the self-vehicle 1 is in the automated driving state, the process advances to step S102. If the self-vehicle 1 is not in the automated driving state, the flowchart ends.

In step S102, the prediction ECU 17 acquires the peripheral information of the self-vehicle 1. This step is performed when the prediction ECU 17 receives the peripheral information of the self-vehicle 1 detected by the detection unit 16.

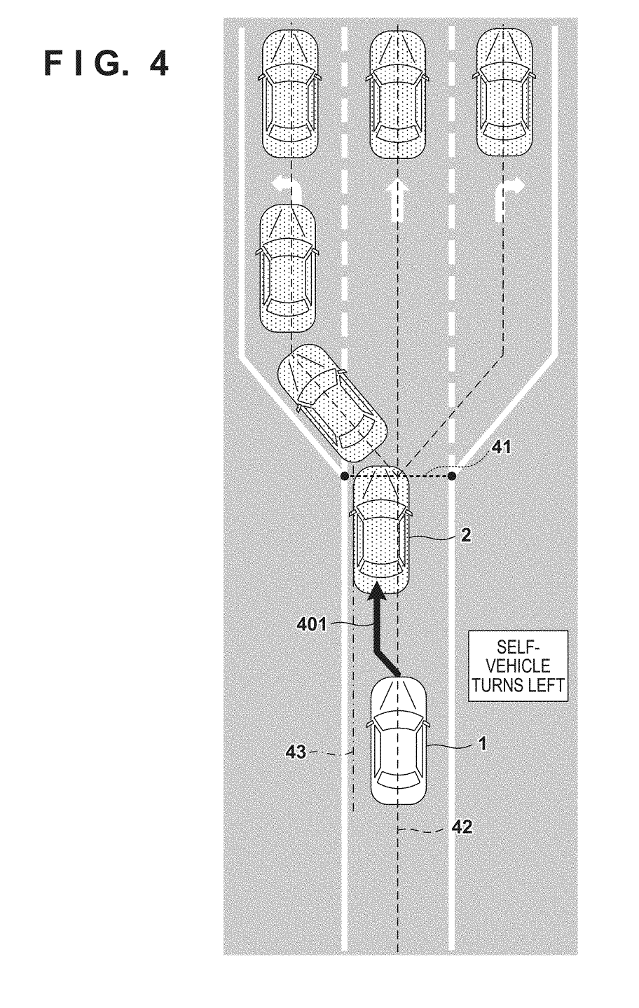

In step S103, the prediction ECU 17 determines whether a branch position to branch from a traveling lane on which the self-vehicle travels to a plurality of lanes in a plurality of advancing directions is specified or not. An example of the branch position is a branch position 41 shown in FIGS. 4 to 7. Detailed of FIGS. 4 to 7 will be described later. In this step, the prediction ECU 17 may receive the peripheral information of the self-vehicle 1 detected by the detection unit 16 and analyze the peripheral information, thereby directly specifying the branch position. Alternatively, the prediction ECU 17 may receive GPS information representing the position of the self-vehicle 1 and specify the branch position existing on the periphery of the self-vehicle 1 based on map information held in advance. If the branch position is specified, the process advances to step S104. On the other hand, if the branch position is not specified, the process advances to step S108.

In step S104, the prediction ECU 17 detects each object existing on the periphery of the self-vehicle 1 from the peripheral information obtained in step S102. This step is performed by performing predetermined data processing (for example, data processing of extracting a contour) for data representing the peripheral information. The prediction ECU 17 then determines whether first another vehicle 2 that is the preceding vehicle of the self-vehicle 1 or second another vehicle 3 that is the following vehicle of the self-vehicle 1, as shown in FIGS. 4 to 7, is detected as an object or not. If the first other vehicle 2 that is the preceding vehicle or the second other vehicle 3 that is the following vehicle is detected, the process advances to step S105. On the other hand, if neither the first other vehicle 2 that is the preceding vehicle nor the second other vehicle 3 that is the following vehicle is detected, the process advances to step S108.

In step S105, the prediction ECU 17 determines whether the self-vehicle 1 is traveling within a predetermined range from the branch position 41 or not. If the branch position is directly specified by analyzing the peripheral information, the determination is done by calculating the distance between the branch position 41 and the self-vehicle 1. Alternatively, if the branch position is specified based on the GPS information representing the position of the self-vehicle 1, the determination is done by calculating the distance between the branch position 41 and the self-vehicle 1 based on the GPS information. If the self-vehicle 1 is traveling within a predetermined range from the branch position 41, the process advances to step S106. On the other hand, if the self-vehicle 1 is not traveling within a predetermined range from the branch position 41, the process advances to step S108.

In step S106, the prediction ECU 17 determines whether at least one of the first other vehicle 2 that is the preceding vehicle and the second other vehicle 3 that is the following vehicle detected in step S104 is located at a position offset with respect to a lane center 42 of the traveling lane. If at least one of the vehicles is located at a position offset with respect to the lane center 42, the process advances to step S107. On the other hand, if neither are located at a position offset with respect to the lane center 42, the process advances to step S108.

In step S107, the driving operation ECU 12 controls an offset operation of the self-vehicle 1 based on the output result from the prediction ECU 17. More specifically, offset control of offsetting the self-vehicle 1 with respect to the lane center 42 is performed based on the offset direction of the detected preceding vehicle or following vehicle and the advancing direction (left turn, straight advance, right turn, or the like) of the self-vehicle 1. The offset control according to this embodiment will be described below with reference to FIGS. 4 to 7.

FIG. 4 is an explanatory view of an example of offset control in a case in which the advancing direction of the self-vehicle is the same as the offset direction of the preceding vehicle. The branch position 41 is specified, the first other vehicle 2 that is the preceding vehicle is detected on the front side of the self-vehicle 1, and the self-vehicle 1 is traveling within a predetermined range from the branch position 41.

In the example shown in FIG. 4, the first other vehicle 2 is offset from the lane center 42 to the left side of the traveling lane in the vehicle width direction so as to move to a lane (left lane) for left turn in a plurality of lanes ahead of the branch position 41. The advancing direction of the self-vehicle 1 is the left turn direction which is the same as the offset direction of the first other vehicle 2. In this case, the driving operation ECU 12 performs offset control to offset the self-vehicle 1 in the same direction as the offset direction of the first other vehicle 2 before the branch position 41 following the first other vehicle 2 that is the preceding vehicle (a course indicated by, for example, an arrow 401).

Accordingly, the offset control is performed at an early stage before entering the branch position. For this reason, if the following vehicle is detected after that, the following vehicle can grasp the behavior of the self-vehicle 1 early. It is therefore possible to perform automated driving with consideration for other vehicles (in particular, the following vehicle).

Note that when offsetting the self-vehicle 1 in the same direction as the offset direction of the preceding vehicle, offset control may be done so the self-vehicle 1 does not move beyond a position 43 parallel to a lateral end face of the preceding vehicle. When the locus of the preceding vehicle is tracked not to offset the self-vehicle more than the preceding vehicle, the frequency of encounter of the self-vehicle with an obstacle can be reduced.

In addition, offset control may be done not to move across the marking line of the traveling lane of the self-vehicle 1. If the lateral end face of the preceding vehicle moves across the marking line, offset control based on the position 43 parallel to the lateral end face is stopped, thereby implementing safer automated driving.

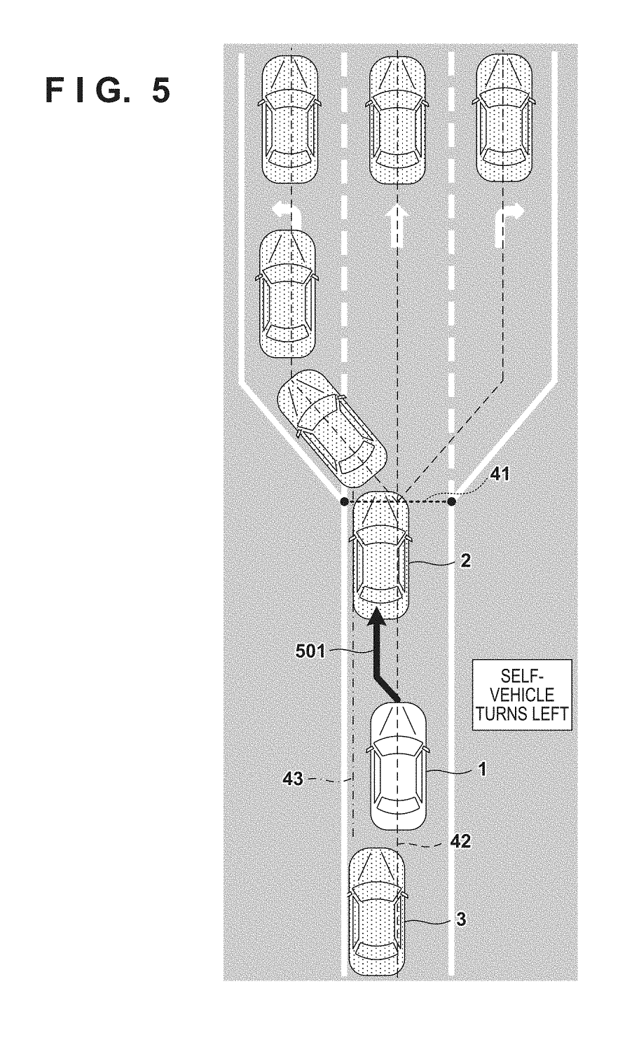

FIG. 5 is an explanatory view of an example of offset control in a case in which the advancing direction of the self-vehicle is the same as the offset direction of the preceding vehicle and the following vehicle. FIG. 5 is different from FIG. 4 in that not only the first other vehicle 2 that is the preceding vehicle but also the second other vehicle 3 that is the following vehicle is detected.

That is, the branch position 41 is specified, the first other vehicle 2 that is the preceding vehicle is detected on the front side of the self-vehicle 1, the second other vehicle 3 that is the following vehicle is detected on the rear side of the self-vehicle 1, and the self-vehicle 1 is traveling within a predetermined range from the branch position 41.

In the example shown in FIG. 5, both the first other vehicle 2 and the second other vehicle 3 are offset from the lane center 42 to the left side of the traveling lane in the vehicle width direction so as to move to the lane (left lane) for left turn in the plurality of lanes ahead of the branch position 41. The driving operation ECU 12 performs offset control to offset the self-vehicle 1 in the same direction as the offset direction of the first other vehicle 2 and the second other vehicle 3 before the branch position 41 following the first other vehicle 2 that is the preceding vehicle and the second other vehicle 3 that is the following vehicle (a course indicated by, for example, an arrow 501). This can prevent only the self-vehicle 1 from being located at a position projecting relative to the first other vehicle 2 and the second other vehicle 3. Note that if the advancing direction of the self-vehicle is different from the offset direction of the preceding vehicle and the following vehicle, offset control may be performed in accordance with the advancing direction of the self-vehicle.

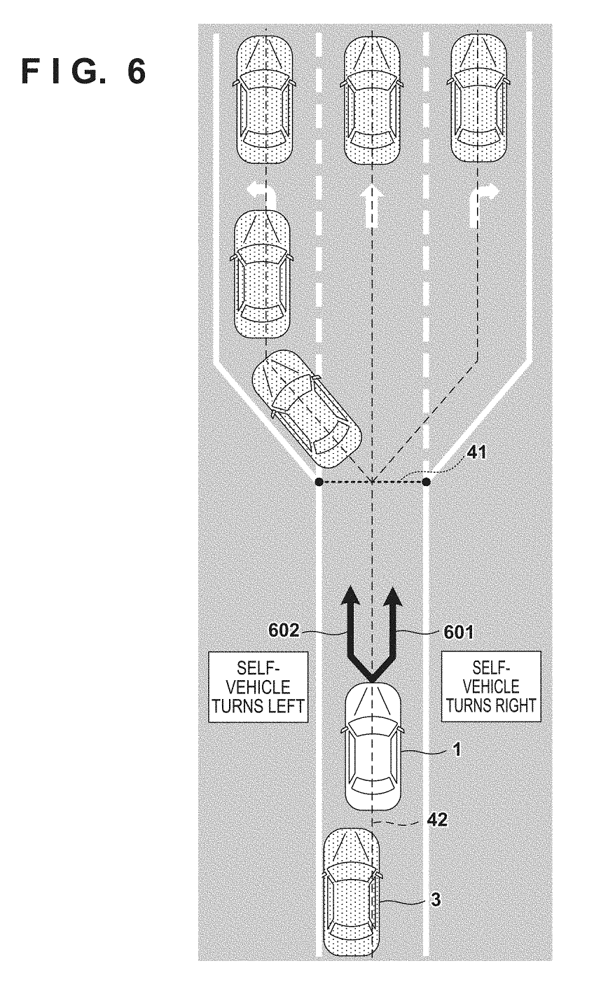

FIG. 6 is an explanatory view of an example of offset control in a case in which the following vehicle is located at a position offset with respect to the lane center or with respect to the self-vehicle, and the advancing direction of the self-vehicle is a direction other than a straight advancing direction (left turn or right turn). The branch position 41 is specified, the second other vehicle 3 that is the following vehicle is detected on the rear side of the self-vehicle 1, and the self-vehicle 1 is traveling within a predetermined range from the branch position 41.

In the example shown in FIG. 6, the advancing direction of the self-vehicle 1 is the right turn direction or the left turn direction, and the second other vehicle 3 that is the following vehicle is offset from the lane center 42 (or with respect to the self-vehicle 1). Here, the second other vehicle 3 is offset from the lane center 42 to the left side of the traveling lane in the vehicle width direction so as to move to the lane (left lane) for left turn. However, the second other vehicle 3 may be offset from the lane center 42 to the right side of the traveling lane in the vehicle width direction so as to move to the lane (right lane) for right turn.

In this case, the driving operation ECU 12 performs offset control to offset the self-vehicle 1 in the same direction as the advancing direction (left turn or right turn) of the self-vehicle 1 with respect to the lane center 42 before the branch position 41. If the advancing direction of the self-vehicle 1 is the right turn direction, the course is indicated by, for example, an arrow 601. If the advancing direction of the self-vehicle 1 is the left turn direction, the course is indicated by, for example, an arrow 602.

Since this can transmit the advancing direction of the self-vehicle to the following vehicle at an early stage, safer automated driving can be implemented.

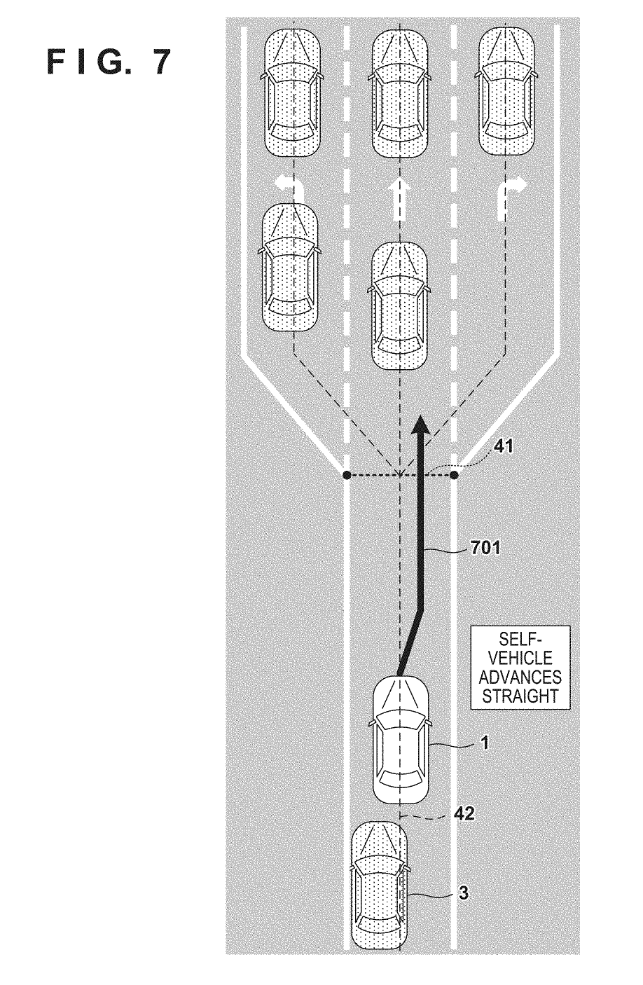

FIG. 7 is an explanatory view of an example of offset control in a case in which the following vehicle is located at a position offset with respect to the lane center or with respect to the self-vehicle, and the advancing direction of the self-vehicle is the straight advancing direction. As in the example shown in FIG. 6, the branch position 41 is specified, the second other vehicle 3 that is the following vehicle is detected on the rear side of the self-vehicle 1, and the self-vehicle 1 is traveling within a predetermined range from the branch position 41.

In the example shown in FIG. 7, the advancing direction of the self-vehicle 1 is the straight advancing direction, and the second other vehicle 3 that is the following vehicle is offset from the lane center 42 (or with respect to the self-vehicle 1). In this case, the driving operation ECU 12 performs offset control to offset the self-vehicle 1 in a direction opposite to the offset direction of the second other vehicle 3 with respect to the lane center 42 before the branch position 41. That is, when the second other vehicle 3 that is the following vehicle is located at a position offset with respect to the lane center 42, and the advancing direction of the self-vehicle 1 is the straight advancing direction, offset control to offset the self-vehicle 1 in the direction opposite to the offset direction of the second other vehicle 3 that is the following vehicle with respect to the lane center 42 is performed. The course is indicated by, for example, an arrow 701.

Here, the second other vehicle 3 is offset from the lane center 42 to the left side of the traveling lane in the vehicle width direction so as to move to the lane (left lane) for left turn. However, the second other vehicle 3 may be offset from the lane center 42 to the right side of the traveling lane in the vehicle width direction so as to move to the lane (right lane) for right turn.

As described above, even if the advancing direction of the self-vehicle is the straight advancing direction, when offset control to offset the self-vehicle in the direction opposite to the offset direction of the following vehicle is performed, the following vehicle can easily enter the lane on the offset direction side near the branch position. It is therefore possible to perform automated driving with consideration for other vehicles (in particular, the following vehicle).

An example of offset control according to this embodiment has been described above with reference to FIGS. 4 to 7. The description will be made below by referring back to the flowchart of FIG. 3.

In step S108, the prediction ECU 17 determines whether to end the automated driving state of the self-vehicle 1. This step is performed when, for example, the prediction ECU 17 receives a signal representing an end of the automated driving state from the driving operation ECU 12. If the automated driving state is not to be ended, the process returns to step S102. If the automated driving state is to be ended, the flowchart ends.

The series of steps S101 to S107 is repetitively performed at a period of, for example, about 10 [msec] or a shorter period. That is, acquisition of the peripheral information of the self-vehicle 1, detection of each object on the periphery of the self-vehicle 1, output of the prediction result of the behaviors of the objects to the driving operation ECU 12, and behavior control of the self-vehicle 1 by the driving operation ECU 12 are periodically performed.

Note that the steps of this flowchart may be changed without departing from the scope of the present invention. For example, the order of the steps may be changed, some steps may be omitted, or another step may be added.

For example, the apparatus may be configured to perform offset control in a case in which at least one of the preceding vehicle and the following vehicle is located at a position offset with respect to the lane center 42 of the traveling lane, and an operation of a direction indicator (for example, blinker) of the at least one vehicle is detected. The operation of the direction indicator may be performed by, for example, analyzing information acquired from the detection unit 16 and detecting blinking of the direction indicator. When the direction indicator is detected together in this way, the offset control of the self-vehicle can be performed while reliably grasping the advancing direction intended by the preceding vehicle or the following vehicle.

In addition, the apparatus may be configured to operate a direction indicator corresponding to the advancing direction of the self-vehicle when performing offset control of the self-vehicle. Since this makes it possible to transmit the behavior of the self-vehicle to other vehicles, safer automated driving can be implemented.

As described above, in this embodiment, when the self-vehicle is traveling within a predetermined range from the branch position, and at least one of the preceding vehicle and the following vehicle is located at a position offset with respect to the lane center of the traveling lane or with respect to the self-vehicle, offset control to offset the self-vehicle with respect to the lane center is performed based on the offset direction of the preceding vehicle or the following vehicle and the advancing direction of the self-vehicle.

According to this embodiment, in a case in which another vehicle is offset when the self-vehicle is located within a predetermined range from the branch position, offset control of the self-vehicle according to the offset direction of the other vehicle and the advancing direction of the self-vehicle is performed early before the branch position, thereby implementing automated driving with consideration for the travel of other vehicles.

### OTHER EMBODIMENTS

Several preferred embodiments have been described above. However, the present invention is not limited to these examples and may partially be modified without departing from the scope of the invention. For example, other elements may be combined with the contents of the embodiments in accordance with the object, application purpose, and the like, and the contents of a certain embodiment may be combined with some of the contents of another embodiment. In addition, individual terms described in this specification are merely used for the purpose of explaining the present invention, and the present invention is not limited to the strict meanings of the terms and can also incorporate their equivalents.

In addition, a program that implements one or more functions described in the embodiments is supplied to a system or apparatus via a network or a storage medium, and one or more processors in the computer of the system or apparatus can read out and execute the program. The present invention can be implemented by this form as well.

### SUMMARY OF EMBODIMENT

A vehicle control apparatus (for example, 12, 17) according to the first aspect comprises:

an acquisition unit (for example, 171, S102) configured to acquire peripheral information of a self-vehicle (for example, 1);

a specifying unit (for example, 171, S103) configured to specify a branch position (for example, 41) to branch from a traveling lane on which the self-vehicle travels to a plurality of lanes in a plurality of advancing directions;

a detection unit (for example, 171, S104) configured to detect one of a preceding vehicle (for example, 2) and a following vehicle (for example, 3) of the self-vehicle based on the peripheral information; and

a control unit (for example, 171, S105-S107) configured to, in a case in which the self-vehicle is traveling within a predetermined range from the branch position, and at least one of the preceding vehicle and the following vehicle is located at a position offset with respect to a lane center (for example, 42) of the traveling lane or with respect to the self-vehicle, perform offset control to offset the self-vehicle with respect to the lane center based on an offset direction of one of the preceding vehicle and the following vehicle and an advancing direction of the self-vehicle.

According to the first aspect, the offset control of the self-vehicle according to the offset direction of the other vehicle and the advancing direction of the self-vehicle is performed early before the branch position, thereby implementing automated driving with consideration for the travel of the other vehicle.

In the second aspect, in a case in which the following vehicle (for example, 3) is located at the position offset with respect to the lane center (for example, 42) or with respect to the self-vehicle, and the advancing direction of the self-vehicle (for example, 1) is a direction (for example, left turn or right turn) other than a straight advancing direction, the control unit performs offset control (for example, 601, 602) to offset the self-vehicle in the same direction as the advancing direction of the self-vehicle with respect to the lane center.

According to the second aspect, since the advancing direction of the self-vehicle can be transmitted to the following vehicle at an early stage, safer automated driving can be implemented.

In the third aspect, in a case in which the following vehicle (for example, 3) is located at the position offset with respect to the lane center (for example, 42) or with respect to the self-vehicle, and the advancing direction of the self-vehicle (for example, 1) is a straight advancing direction, the control unit performs offset control (for example, 701) to offset the self-vehicle in a direction opposite to the offset direction of the following vehicle with respect to the lane center.

According to the third aspect, even if the advancing direction of the self-vehicle is the straight advancing direction, when offset control to offset the self-vehicle in the direction opposite to the offset direction of the following vehicle is performed, the following vehicle can easily enter the lane on the offset direction side near the branch position. It is therefore possible to perform automated driving with consideration for other vehicles (in particular, the following vehicle).

In the fourth aspect, in a case in which both the preceding vehicle (for example, 2) and the following vehicle (for example, 3) are located at positions offset in the same direction with respect to the lane center (for example, 42) or with respect to the self-vehicle, and the advancing direction of the self-vehicle (for example, 1) is the same direction as the offset direction of the preceding vehicle and the following vehicle, the control unit performs offset control (for example, 501) to offset the self-vehicle in the same direction with respect to the lane center.

According to the fourth aspect, it is possible to prevent only the self-vehicle from being located at a position projecting relative to the preceding and following vehicles.

In the fifth aspect, in a case in which the preceding vehicle (for example, 2) is located at the positions offset with respect to the lane center (for example, 42) or with respect to the self-vehicle, and the advancing direction of the self-vehicle (for example, 1) is the same direction as the offset direction of the preceding vehicle, the control unit performs offset control (for example, 401) to offset the self-vehicle in the same direction with respect to the lane center.

According to the fifth aspect, the offset control is performed at an early stage before entering the branch position. For this reason, if the following vehicle is detected after that, the following vehicle can grasp the behavior of the self-vehicle 1 early. It is therefore possible to perform automated driving with consideration for other vehicles (in particular, the following vehicle).

In the sixth aspect, when offsetting the self-vehicle (for example, 1) in the same direction as the offset direction of the preceding vehicle (for example, 2), the control unit performs the offset control so the self-vehicle does not move beyond a position (for example, 43) parallel to a lateral end face of the preceding vehicle.

According to the sixth aspect, when the locus of the preceding vehicle is tracked not to offset the self-vehicle more than the preceding vehicle, the frequency of encounter of the self-vehicle with an obstacle can be reduced.

In the seventh aspect, the control unit performs the offset control not to move across a marking line (for example, a white line) of the traveling lane.

According to the seventh aspect, since the self-vehicle does not move across the marking line, safer automated driving can be implemented. In addition, if the lateral end face of the preceding vehicle moves across the marking line, offset control based on the position parallel to the lateral end face is stopped, thereby implementing safer automated driving.

In the eighth aspect, the control unit performs the offset control in a case in which at least one of the preceding vehicle (for example, 2) and the following vehicle (for example, 3) is located at the position offset with respect to the lane center (for example, 42) of the traveling lane or with respect to the self-vehicle, and an operation of a direction indicator (for example, a blinker) of the at least one vehicle is detected.

According to the eighth aspect, when the direction indicator is detected together, the offset control of the self-vehicle can be performed while reliably grasping the advancing direction intended by the preceding vehicle or the following vehicle.

In the ninth aspect, the control unit operates a direction indicator (for example, a blinker) corresponding to the advancing direction of the self-vehicle when performing the offset control.

According to the ninth aspect, since it is possible to transmit the behavior of the self-vehicle to other vehicles, safer automated driving can be implemented.

In the 10th aspect, the specifying unit specifies the branch position based on the peripheral information (for example, camera information).

According to the 10th aspect, even if a navigation system is not provided in the self-vehicle, the branch position can be specified.

In the 11th aspect, the specifying unit specifies the branch position based on map information and GPS information representing a position of the self-vehicle.

According to the 11th aspect, the position of the self-vehicle can more correctly be grasped.

A vehicle (for example, 1) according to the 12th aspect comprises a vehicle control apparatus (for example, 12, 17) according to any one of the first to 11th aspects.

According to the 12th aspect, offset control of the self-vehicle according to the offset direction of the other vehicle and the advancing direction of the self-vehicle is performed early before the branch position, thereby implementing automated driving with consideration for the travel of the other vehicle.

A processing method of a vehicle control apparatus (for example, 12, 17) according to the 13th aspect comprises:

acquiring peripheral information of a self-vehicle (for example, 171, S102);

specifying a branch position (for example, 41) to branch for a traveling lane on which the self-vehicle travels to a plurality of lanes in a plurality of advancing directions (for example, 171, S103);

detecting one of a preceding vehicle (for example, 2) and a following vehicle (for example, 3) of the self-vehicle based on the peripheral information (for example, 171, S104); and

in a case in which the self-vehicle is traveling within a predetermined range from the branch position, and at least one of the preceding vehicle and the following vehicle is located at a position offset with respect to a lane center (for example, 42) of the traveling lane or with respect to the self-vehicle, performing offset control to offset the self-vehicle with respect to the lane center based on an offset direction of one of the preceding vehicle and the following vehicle and an advancing direction of the self-vehicle (for example, 171, S105-S107).

According to the 13th aspect, as in the first aspect, the offset control of the self-vehicle according to the offset direction of the other vehicle and the advancing direction of the self-vehicle is performed early before the branch position, thereby implementing automated driving with consideration for the travel of the other vehicle.

The 14th aspect is directed to a storage medium storing a program configured to cause a computer to execute steps of a processing method of a vehicle control apparatus according to the 13th aspect.

According to the 14th aspect, the processing method of the vehicle control apparatus of the 13th aspect can be implemented by a computer.

According to the present invention, it is possible to implement automated driving with consideration for the travel of other vehicles.

This application claims the benefit of Japanese Patent Application No. 2017-175784, filed Sep. 13, 2017, which is hereby incorporated by reference herein in its entirety.

What is claimed is:

1. A vehicle control apparatus comprising:
an acquisition unit configured to acquire peripheral information of a self-vehicle;
a specifying unit configured to specify a branch position to branch from a traveling lane on which the self-vehicle travels to a plurality of lanes in a plurality of advancing directions;
a detection unit configured to detect one of a preceding vehicle and a following vehicle of the self-vehicle based on the peripheral information; and
a control unit configured to, in a case in which the self-vehicle is traveling within a predetermined range from the branch position, and at least one of the preceding vehicle and the following vehicle is located at a position offset with respect to a lane center of the traveling lane or with respect to the self-vehicle, perform offset control to offset the self-vehicle with respect to the lane center based on an offset direction of one of the preceding vehicle and the following vehicle and an advancing direction of the self-vehicle.

2. The apparatus according to claim 1, wherein in a case in which the following vehicle is located at the position offset with respect to the lane center or with respect to the self-vehicle, and the advancing direction of the self-vehicle is a direction other than a straight advancing direction, the control unit performs offset control to offset the self-vehicle in the same direction as the advancing direction of the self-vehicle with respect to the lane center.

3. The apparatus according to claim 1, wherein in a case in which the following vehicle is located at the position offset with respect to the lane center or with respect to the self-vehicle, and the advancing direction of the self-vehicle is a straight advancing direction, the control unit performs offset control to offset the self-vehicle in a direction opposite to the offset direction of the following vehicle with respect to the lane center.

4. The apparatus according to claim 1, wherein in a case in which both the preceding vehicle and the following vehicle are located at positions offset in the same direction with respect to the lane center or with respect to the self-vehicle, and the advancing direction of the self-vehicle is the same direction as the offset direction of the preceding vehicle and the following vehicle, the control unit performs offset control to offset the self-vehicle in the same direction with respect to the lane center.

5. The apparatus according to claim 1, wherein in a case in which the preceding vehicle is located at the positions offset with respect to the lane center or with respect to the self-vehicle, and the advancing direction of the self-vehicle is the same direction as the offset direction of the preceding vehicle, the control unit performs offset control to offset the self-vehicle in the same direction with respect to the lane center.

6. The apparatus according to claim 5, wherein when offsetting the self-vehicle in the same direction as the offset direction of the preceding vehicle, the control unit performs the offset control so the self-vehicle does not move beyond a position parallel to a lateral end face of the preceding vehicle.

7. The apparatus according to claim 1, wherein the control unit performs the offset control not to move across a marking line of the traveling lane.

8. The apparatus according to claim 1, wherein the control unit performs the offset control in a case in which at least one of the preceding vehicle and the following vehicle is located at the position offset with respect to the lane center of the traveling lane or with respect to the self-vehicle, and an operation of a direction indicator of the at least one vehicle is detected.

9. The apparatus according to claim 1, wherein the control unit operates a direction indicator corresponding to the advancing direction of the self-vehicle when performing the offset control.

10. The apparatus according to claim 1, wherein the specifying unit specifies the branch position based on the peripheral information.

11. The apparatus according to claim 1, wherein the specifying unit specifies the branch position based on map information and GPS information representing a position of the self-vehicle.

12. A vehicle comprising a vehicle control apparatus of claim 1.

13. A processing method of a vehicle control apparatus, comprising:
acquiring peripheral information of a self-vehicle;
specifying a branch position to branch for a traveling lane on which the self-vehicle travels to a plurality of lanes in a plurality of advancing directions;
detecting one of a preceding vehicle and a following vehicle of the self-vehicle based on the peripheral information; and
in a case in which the self-vehicle is traveling within a predetermined range from the branch position, and at least one of the preceding vehicle and the following vehicle is located at a position offset with respect to a lane center of the traveling lane or with respect to the self-vehicle, performing offset control to offset the self-vehicle with respect to the lane center based on an offset direction of one of the preceding vehicle and the following vehicle and an advancing direction of the self-vehicle.

14. A storage medium storing a program configured to cause a computer to execute steps of a processing method of a vehicle control apparatus of claim 13.
